(19) United States
(12) Patent Application Publication
(10) Pub. No.: US 2003/0030629 A1
(43) Pub. Date: Feb. 13, 2003

(54) Display device, method of driving a display device , electronic apparatus

(76) Inventors: Simon Tam, Cambridge (GB); Richard Friend, Cambridge (GB)

Correspondence Address: Oliff & Berridge, P O Box 19928, Alexandria, VA, 22320, US

(21) Appl. No.: 10/148,136

(22) PCT Filed: Sep. 28, 2001
(86) PCT No.: PCT/GB01/04376

(30) Foreign Application Priority Data
Sep. 28, 2000 (GB) 0023787.5

(51) Int. Cl. G09G 5/00

(52) U.S. Cl. 345/204

(57) ABSTRACT

A display device comprising a driver circuit which modulates the duty cycle of the on-state of a pixel during a frame period. Preferably the driver circuit comprises a comparator and more preferably the comparator is formed of thin film transistors constituting a differential pair and an inverter. Also provided is a method of driving a display device comprising the step of modulating the duty cycle of the on-state of a pixel during a frame period. Beneficially the display device is an organic electroluminescent active matrix display device.

The present invention relates to display devices and in particular to improving the display quality thereof. The invention also relates to a method and an electronic apparatus.

One example of a display device to which the present invention relates is an organic electroluminescent display device. Organic electroluminescent devices (OELDs) comprise a layer (active layer) of organic light emitting material, often a light emitting polymer, sandwiched between two electrodes which are used to pass a current through the active material. The device essentially behaves like a diode and the intensity of light emission is a function of the forward bias current which is applied. The devices are good candidates for the fabrication of display panels.

A basic requirement for a display panel is an ability to display good quality graphical images. This is dependent upon the ability of the individual pixels to generate a range of brightness intensity. The image quality improves as the number of gray scales increases. The conventionally used standard is 3×8 bit colour, equivalent to 256 gray scales per colour. This standard is used in many current day applications.

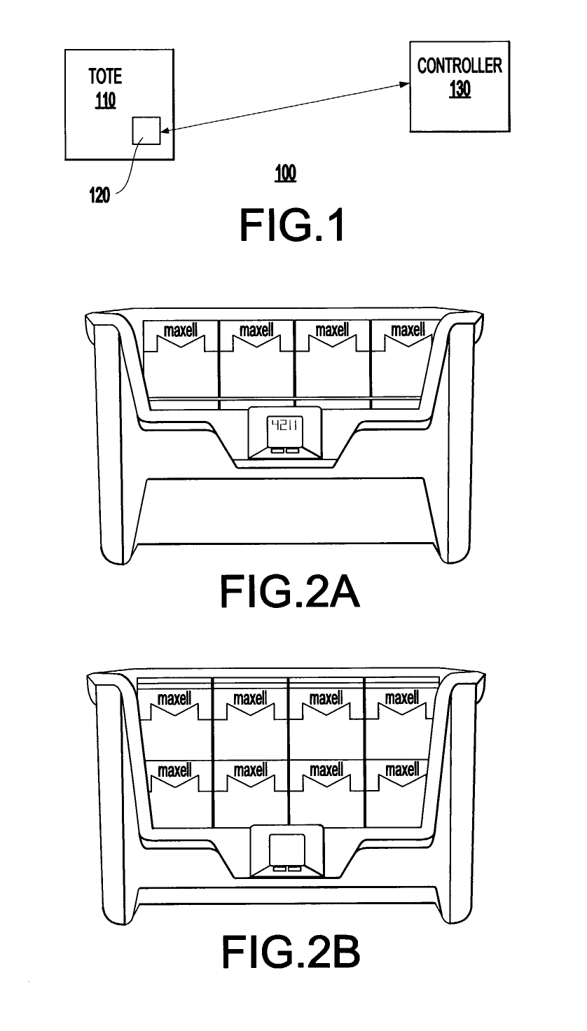

Various methods of generating gray scales with an analog driving circuit have been proposed for OELD displays. The conventional technique is to drive the OELD with a voltage dependent current and this has allowed the implementation of active matrix OELD displays. A typical arrangement is illustrated in FIG. 1 hereof.

As shown in FIG. 1, when transistor T₁ is selected (by voltage Vₛₑₗ) it turns on and the data voltage (V_{dat}) is transferred to the gate of transistor T₂. Assuming T₂ is biased in the saturation region, the data voltage V_{dat} is converted into current, which drives the OELD to the required brightness intensity.

The variation of threshold voltages of the transistors is, however, a very significant problem in the practical implementation of the above described display panels. Another significant problem is the high power consumption of these circuits.

An alternative method of providing gray scaling is to use an area dithering technique in which each pixel is divided in to a number of sub-pixels, preferably with binary weighted areas. Each sub-pixel is driven either fully on or fully off. Thus a digital driver can be used and power consumption reduced. However, this technique has the disadvantage that the panel size is increased (because each pixel is replaced by a number of sub-pixels and, in the limit, each sub-pixel is the same size as a conventional pixel) and also there is a large increase in the number of signal lines required (because of the need to address each sub-pixel).

Against this background, it is an object of the present invention to provide a display device with good gray scale capabilities which mitigates the above mentioned disadvantages.

According to the present invention there is provided a display device comprising a driver circuit which modulates the duty cycle of the on-state of a pixel during a frame period.

Thus, the present invention provides pulse width modulation of the on-period of a pixel and the integrating function of the human eye perceives this as modulation of the intensity of the emitted light. Modulation of the on-period is in stark contrast to the conventional control of brightness, ie control of the instantaneous amplitude of the current supplied.

Embodiments of the present invention will now be described in more detail by way of further example only and with reference to the accompanying drawings, in which:

FIG. 1 is a circuit diagram of a conventional pixel level driver in an OELD display panel;

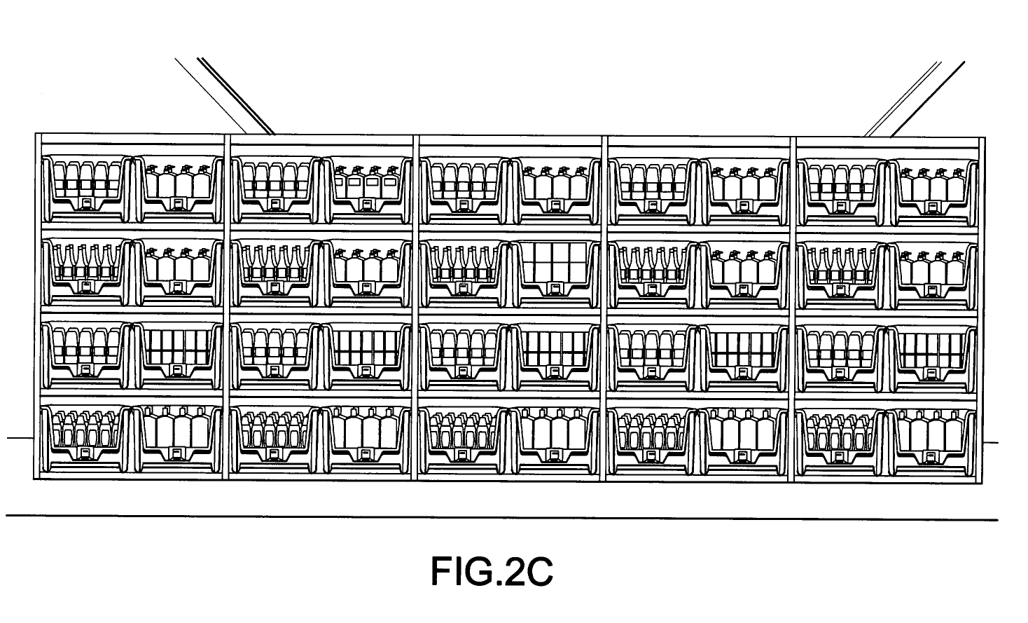

FIG. 2 is a circuit diagram of a pixel level driver in an OELD display panel, according to one embodiment of the present invention;

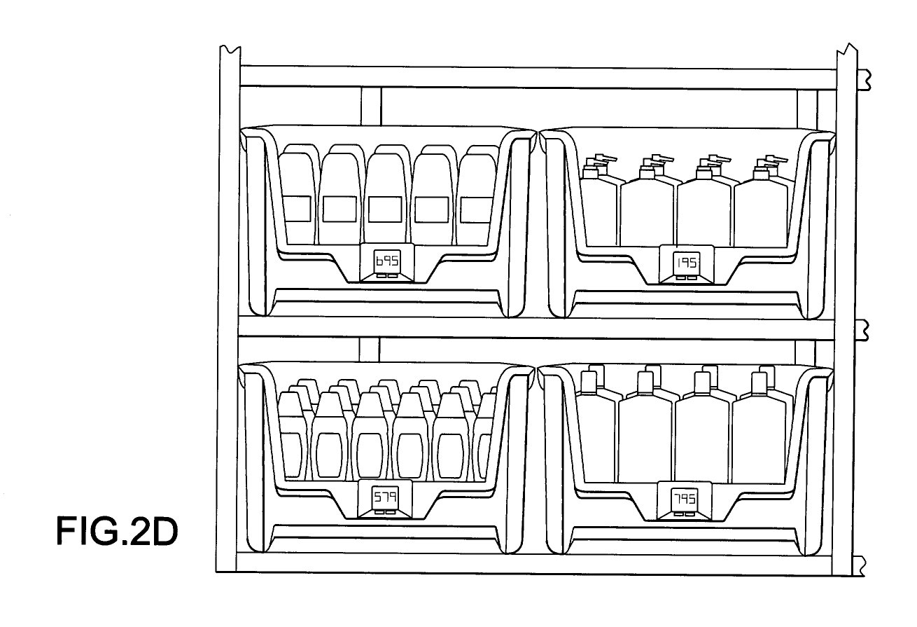

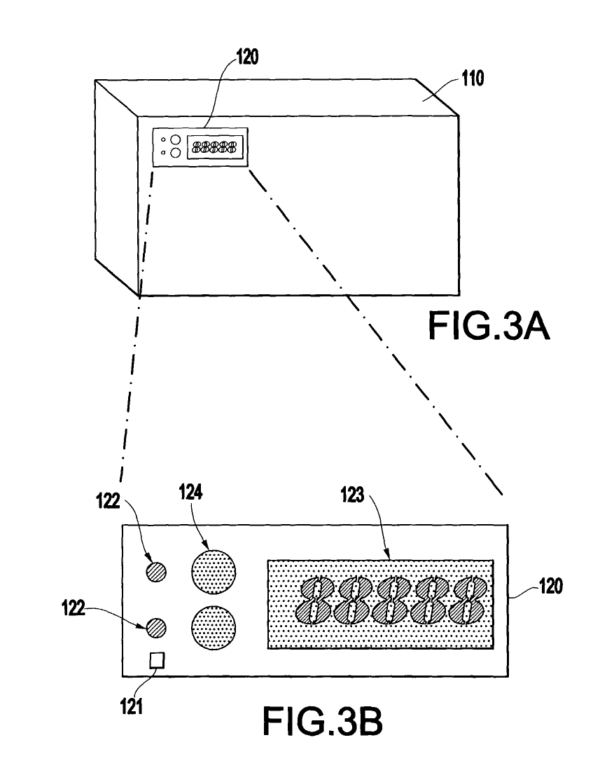

FIG. 3 illustrates a detailed circuit diagram and operating waveforms for an implementation of the comparator shown in the circuit of FIG. 2;

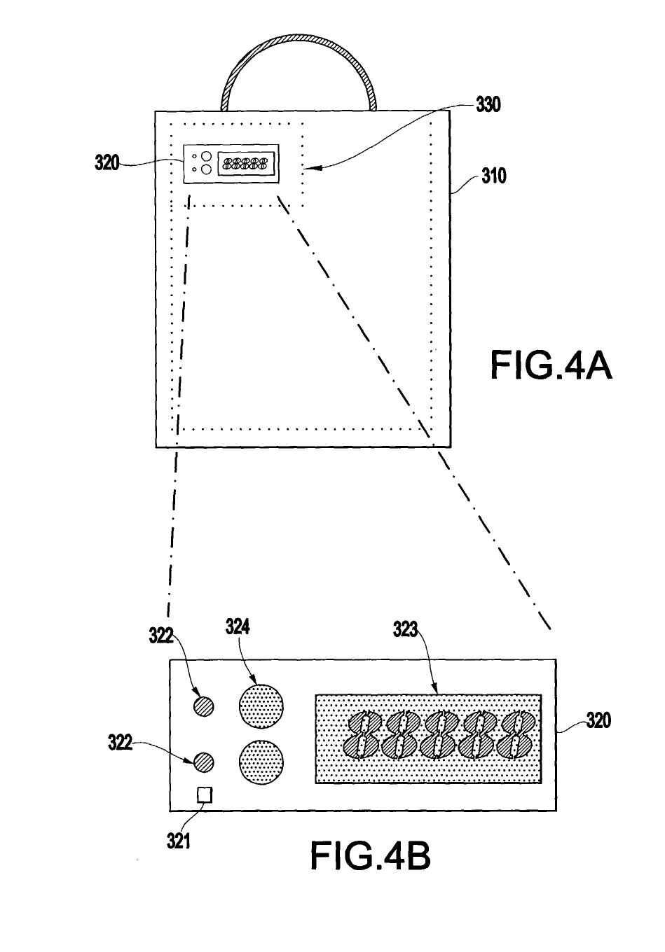

FIG. 4 illustrates driving waveforms in the circuit of FIG. 2;

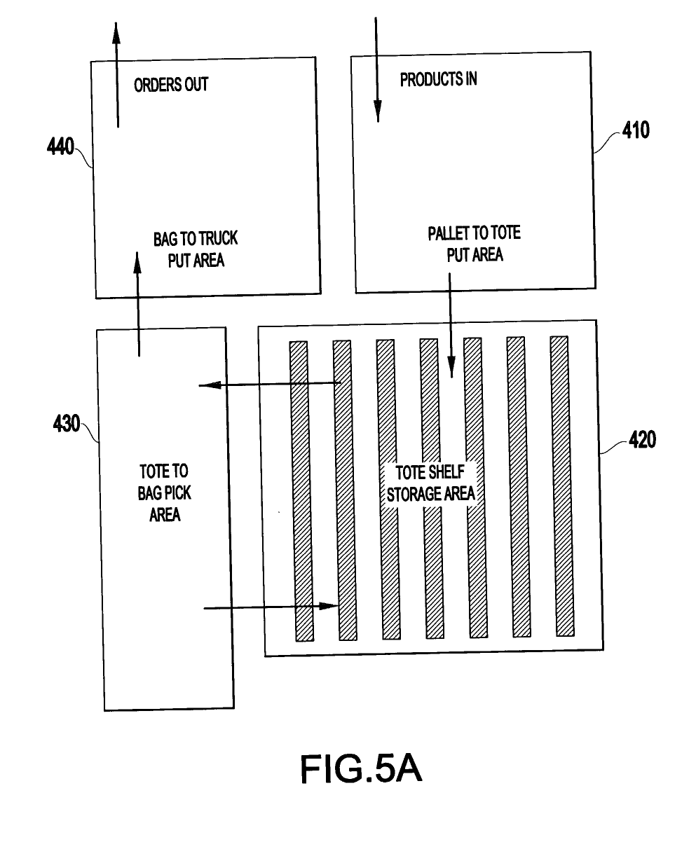

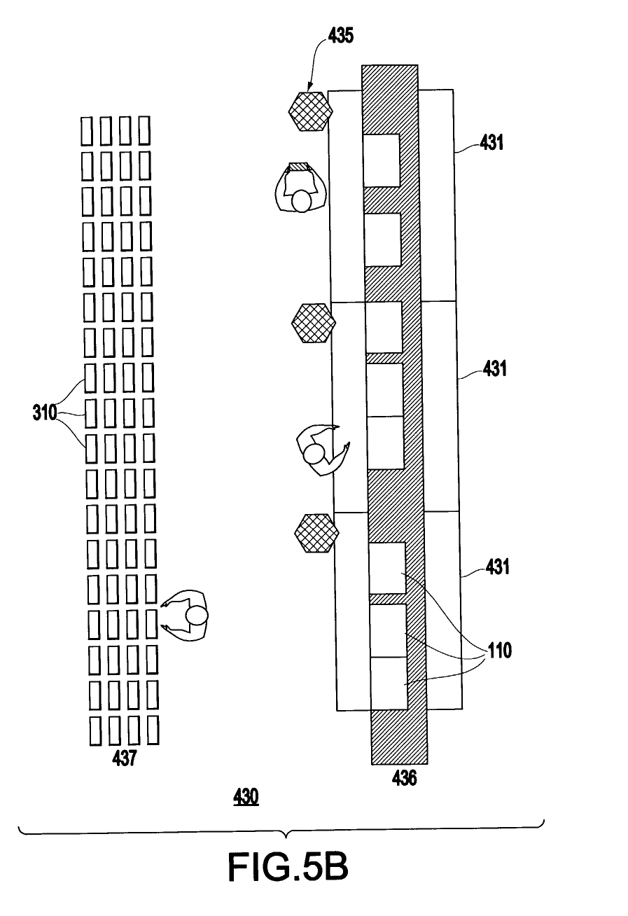

FIG. 5 is a circuit diagram illustrating the use of an integrated waveform generator;

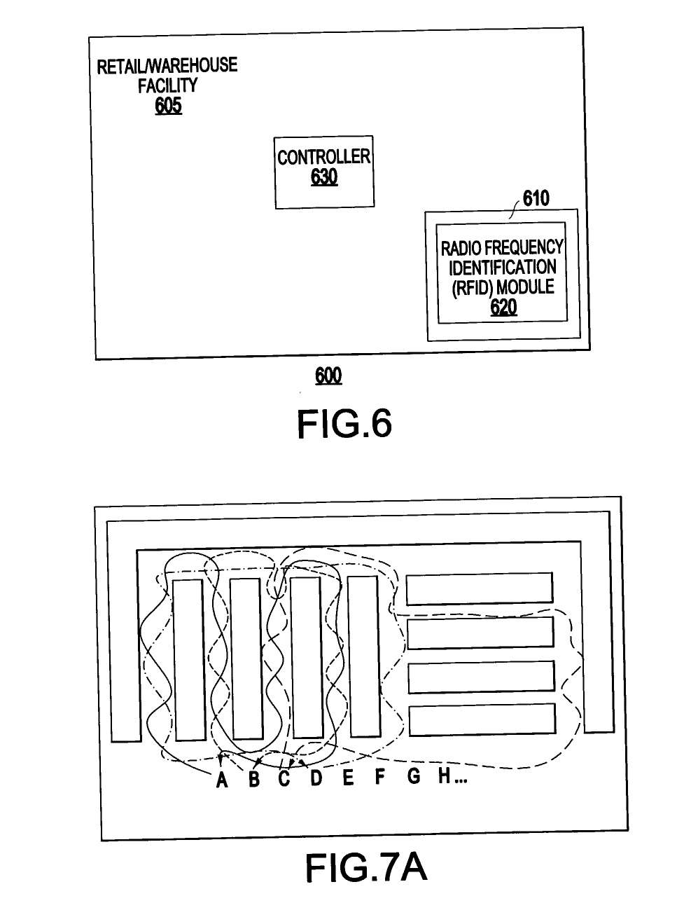

FIG. 6 illustrates a generalised synchronous driving scheme;

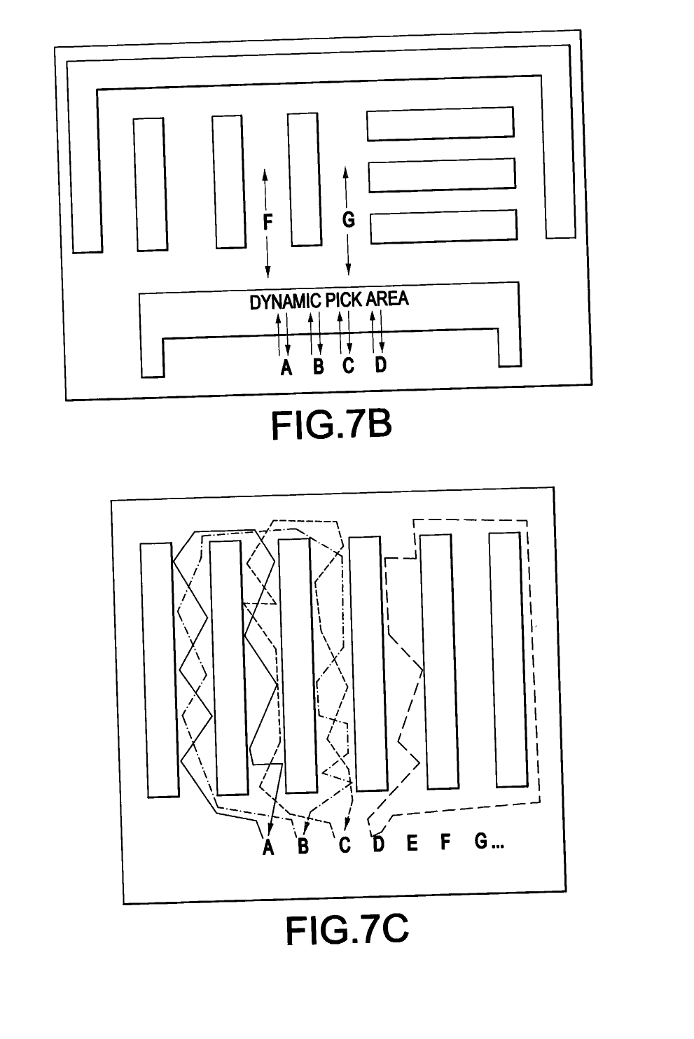

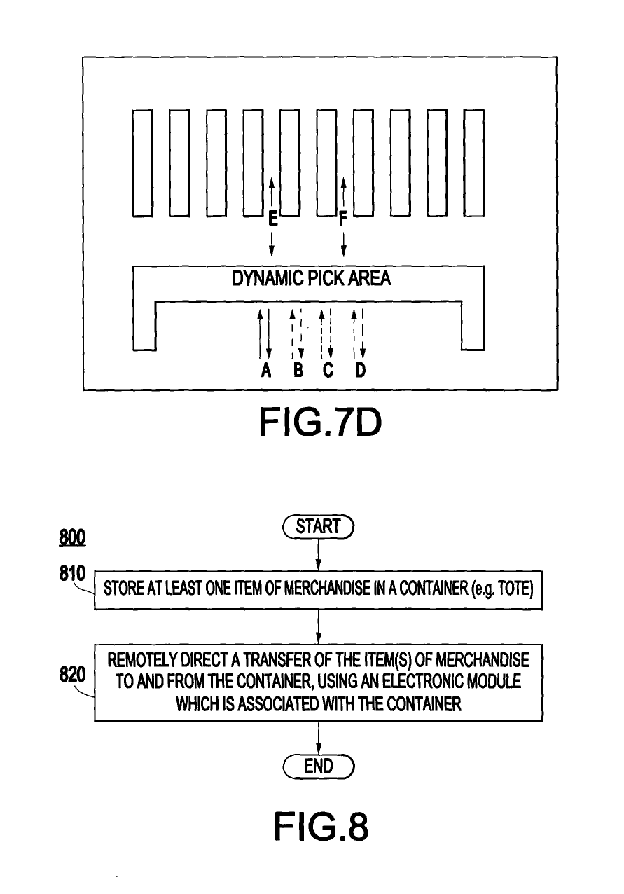

FIG. 7 illustrates a generalised asynchronous driving scheme;

FIGS. 8A and 8B show the significance of using higher frequencies in the asynchronous driving scheme;

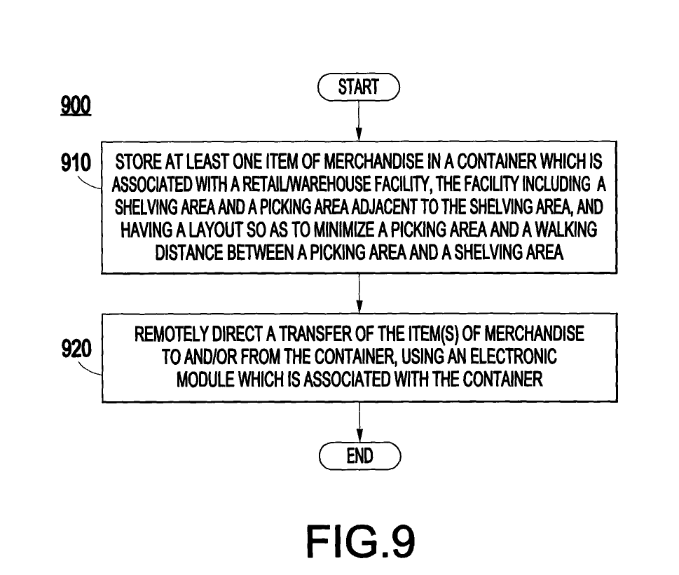

FIGS. 9A and 9B illustrate the incorporation of gamma correction in to the driving voltage;

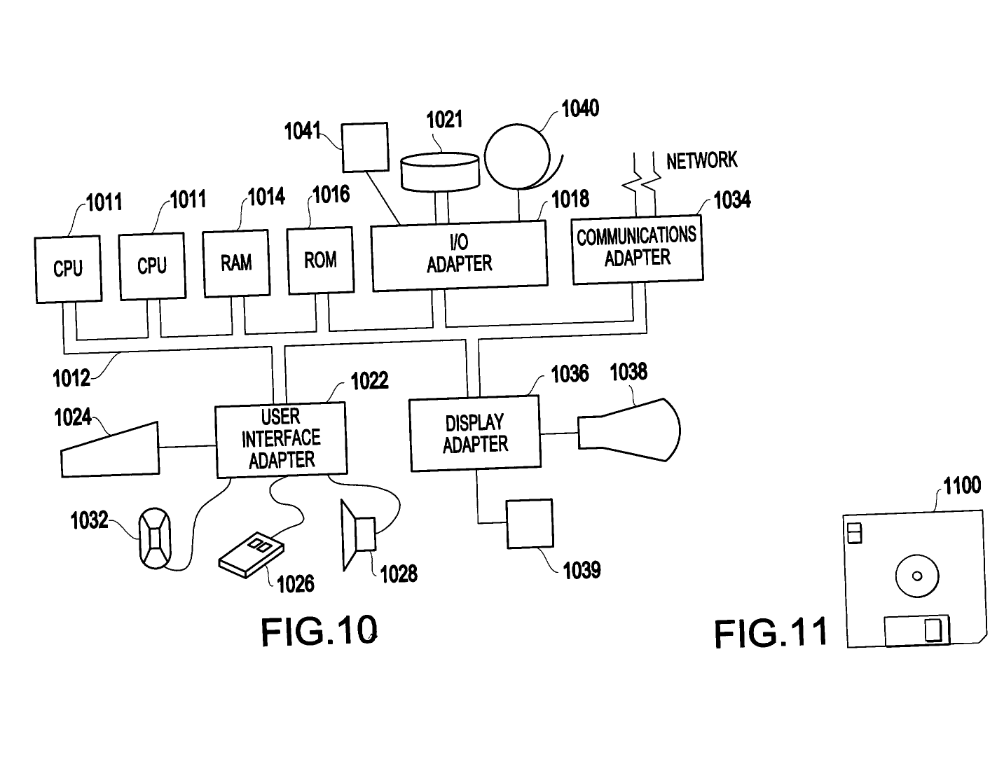

FIG. 10 is a detailed circuit diagram of a sawtooth wave generator;

FIG. 11 shows input waveforms for the circuit of FIG. 10;

FIGS. 12A and 12B show gray scales obtained in a specific example;

FIG. 13 is a schematic view of a mobile personal computer incorporating a display device having a pixel driver according to the present invention,

FIG. 14 is a schematic view of a mobile telephone incorporating a display device having a pixel driver according to the present invention, and

FIG. 15 is a schematic view of a digital camera incorporating a display device having a pixel driver according to the present invention,

A description will first be given of the pixel level configuration according to one embodiment of the present invention. Thus, FIG. 2 is a circuit diagram of an individual pixel 10 within an active matrix OELD display panel. The circuit is implemented using polysilicon TFT components and comprises an MOS-input comparator 12 and two pass-gates, SW₁ and SW₂. The use of pass-gates avoids so-called “feed-through”, i.e. coupling with other circuit voltages. The inverting input (+) of the comparator 12 is connected to a waveform source V_{saw}. The non-inverting input (−) is connected to a storage capacitor C₁ and a pass-gate SW₁. The pass-gate SW₁ is controlled by a waveform Vₛₑₗ. The output of the comparator is connected to a pass-gate SW₂. Pass-gate SW₂ controls the current flowing in to the organic light emitting element 14. By applying a time varying signal to V_{saw}, the light emitting element 14 is switched on for a period depending on the value of the data voltage V_{dat} which is applied to the other side of pass-gate SW₁ compared to the capacitor C₁ and the comparator 12.

In a line-at-a-time driving scheme, Vₛₑₗ sets the state of the pass-gate SW₁ of the pixel elements on the same row. When pass-gate SW₁ is closed, the data voltage V_{dat} is transferred to the inverting input of the comparator 12 and to the capacitor C₁. Then, when pass-gate SW₁ is opened the data voltage is memorised by capacitor C₁. The waveform V_{saw} is then initiated. When the voltage, V₊, at the inverting input of the comparator 12 is less than the voltage, V−, at the non-inverting input thereof, the comparator outputs a LO signal which puts the light emitting element 14 in to the on-state. When the voltage, V₊, at the inverting input of the comparator 12 is greater than the voltage, V−, at the non-inverting input thereof, the comparator outputs a HI signal which puts the light emitting element 14 in to the off-state. As a result the data voltage stored by the capacitor C₁ modulates the duration for which the light emitting element 14 remains in the on-state during a frame period.

The frame period might typically be 20 mS and with the response time of the light emitting element 14 being of the order of nano-seconds, the speed of the polysilicon TFTs and any stray capacitance become the limiting factors in operation of the driving scheme. That is, exceptionally effective switching can be obtained.

In the circuit illustrated in FIG. 2, a common operating voltage V_{OELD} is used for all OELD pixels of the same type. The voltage V_{OELD} is set externally and is independent of the supply voltage V_{DD} of the driving circuit. This significantly increases the flexibility of controlling the bias conditions for the OELDs.

A description will now be given of the detailed considerations which apply to the practical implementation of the comparator 12 used in the circuit of FIG. 2.

Since a separate comparator is provided for each pixel, the circuit area and power consumption of the comparator should be kept as low as possible. Further, in order to achieve a high number of gray scales, the comparator must be able to distinguish a small difference in input voltages. For example, if it is desired to implement 256 gray scales with a voltage swing of 0V to 5V then clearly something of the order of ΔV=19.5 mV is appropriate. Thus switching must be very fast but, from the previous discussion, it is well within the ability of the described circuit.

A detailed circuit diagram of one implementation of the comparator 12 of FIG. 2 is illustrated in FIG. 3. The circuit of FIG. 3 comprises two stages: a CMOS differential amplifier 16, and a CMOS inverter 18. The CMOS inverter 18 turns the pass-gate SW₂ fully on or fully off very quickly. For level shifting purposes the power supply of the inverter stage 18 can be different from that of the differential stage 16.

The differential stage 16 comprises the drain-source series connection circuit of transistors 20, 21 and 23 connected between the V_{DD} rail and ground, together with the similarly connected circuit of transistors 20, 22 and 24, wherein transistors 22 and 24 are connected in parallel with transistors 21 and 23. The respective gates of transistors 21 and 22 provide the two input terminals (+), (−) of the comparator 12, whereas the gate of transistor 20 receives a bias voltage V_{bias}. The output stage 18 comprises two transistors, 25 and 26, which are source-drain series connected between the V_{DD} rail and ground. The output Vₒᵤₜ of the comparator is taken from the connection between the transistors 25 and 26 and the gates thereof receive there input from the junction between transistors 21 and 23.

The circuit illustrated in FIG. 3 uses seven TFTs. Using a respective TFT for SW₁ and SW₂ brings the total per pixel to nine.

A description will now be given of various aspects of implementing a display panel incorporating the above described embodiment of pixel level circuitry.

FIG. 4 illustrates waveforms which can be used with the circuit of FIG. 2. FIG. 4 comprise two diagrams, (a) and (b), in which the waveforms V_{scan}, V_{saw} and Vₒᵤₜ are shown. Vₒᵤₜ is the driving pulse applied to the OELD. FIGS. 4(a) and (b) differ in the shape of the waveform used for V_{saw}. In FIG. 4(a) the waveform of V_{saw} is a sawtooth whereas in FIG. 4(b) the waveform of V_{saw} is triangular. Using the sawtooth waveform of FIG. 4(a) the output pulse always starts at the beginning of each frame. Thus the sawtooth waveform of FIG. 4(a) provides a linear gray scale, as it provides a reference time point for the eye to start integrating for each frame. For the triangular waveform of FIG. 4(b) the centre of the output pulse always occurs at mid-cycle.

Basically all pixels in the same row of the matrix share the same driving waveform, denoted by V_{saw/m} where m indicates that it is the m^{th}-row of the matrix which is being considered. When rows are addressed sequentially, the driving waveforms for the next row, denoted by V_{saw/m+1}, should incorporate a delay or phase shift of T_{frame/M}, where T_{frame} is the frame period and M is the total number of rows in the matrix. Thus if the display is driven externally a total of M interconnections are required. This can be a problem for high resolution displays. Thus, according to one embodiment of the present invention there is provided an integrated waveform generator, by which the number of interconnections required can be reduced.

FIG. 5 is a circuit diagram illustrating the use of an integrated waveform generator. The waveform generator 30 receives separate master and reference voltage inputs, Vₘₐₛₜₑᵣ and V_{ref}. The waveform generator 30 also receives an input from V_{scan/m}. The generator output V_{saw/m} is applied to all of the pixels 10 in a particular row of the matrix.

Ideally, however, the function of the generators is to provide the same waveform with a unique phase shift for each row of pixel elements. The precise timing and data voltage relationship becomes a major challenge when the spatial variation of TFT characteristics over a display panel is taken into account. However, this problem can be solved by providing the master clock Vₘₐₛₜₑᵣ and the reference voltage source V_{ref} to ensure that outputs from all waveform generators are the same but different in phase shift.

The waveform generator should be synchronised to V_{scan/m}, and thus the signal V_{scan/m} can be used as a trigger.

From the foregoing description, a generalised synchronous driving scheme is illustrated in FIG. 6. Two rows and six columns of pixels are illustrated. As denoted by R, G, B indicating red, green and blue; the light emitting element in each pixel may be designed to emit light of different colours thus implementing a full colour display. The pixels are driven by a data driver 32 and a row driver 34. A separate waveform generator, WG, is provided for each row and the signals applied are indicated in FIG. 6. Each waveform generator is synchronised to the scan line signal and the minimum operating frequency is equal to the frame rate.

The display can also be driven asynchronously. An asynchronous driving scheme is shown in FIG. 7. The difference between this arrangement and that illustrated in FIG. 6 is that a single waveform generator is used for the whole display rather than using one per row. With this arrangement the waveform generator can be integrated on the display panel or can easily be provided externally of the panel. The waveform is independent of the scan line signal and higher operating frequencies can thus be used, thereby obtaining better image quality. The significance of using higher frequencies can be appreciated from FIGS. 8A and 8B, that is the improved gray scale accuracy of FIG. 8B (high frequency V_{DRV}) compared with FIG. 8A (low frequency V_{DRV}) is readily apparent. This phenomenon is important for moving images but can effectively be ignored for still images.

It is also possible to incorporate gamma compensation into the driving waveform. This is illustrated in FIGS. 9A and 9B, which show gamma correction incorporated in to the driving voltage V_{DRV}.

FIG. 10 is a detailed circuit diagram of a sawtooth waveform generator such as may be employed in the above described embodiments of the present invention. The circuit receives an input signal V_{gray} which is applied to one terminal of a capacitor C₂₀. The other terminal of capacitor C₂₀ is connected to one side of each of switches SW₁₀ and SW₂₀. These switches SW₁₀ and SW₂₀ are controlled by signals φ₁ and φ₂, respectively. The other side of switch SW₂₀ is connected to ground via a capacitor C₁₀ and also via a switch SW₃₀ which is controlled by signal V_{scan}. Switches SW₂₀, SW₃₀ and capacitor C₁₀ are connected to the input of a unity gain buffer 36. Switch SW₁₀ controls a feedback loop from the output of the buffer 36. The output of the buffer 36 is applied to a low-pass filter L.P. consisting of a resistor and a capacitor. The out put of the filter L.P. provides the generator output V_{saw}.

As noted above, the circuit has four inputs (V_{gray}, φ₁, φ₂ and V_{scan}) and one output (V_{saw}). The input waveforms are shown in FIG. 11.

Waveform V_{gray} operates between 0V and a maximum level, say h. Waveforms φ₁ and φ₂ are non-overlapping clock pulses and V_{scan} is the same signal as in the scan line. When V_{scan} goes HI, data is transferred to the pixel storage capacitor as described above. At the same time, V_{scan} signals SW₃₀ to close so that the input of the unity gain buffer is at 0V and C₁₀ is discharged. Effectively, this acts as a reset and zeros the output. When V_{scan} goes LO, SW₃₀ is opened. Waveform V_{gray}=0V when SW₂₀ is closed and SW₁₀ is opened. The transition of V_{gray} from 0V to h raises the input voltage at the unity gain buffer. If C₁₀=C₂₀, this increment equals h/2. When V_{gray}=h, SW₂₀ is opened and SW₁₀ is closed. The unity gain buffer 32 input voltage is stored by C₁₀. This voltage is reflected by the output of the unity gain buffer and is connected to C₂₀ while V_{gray} returns to 0V. Next SW₁₀ is opened and then SW₂₀ is closed, and then V_{gray} will transit from 0V to h. This will increase further the voltage at the input of the unity gain buffer 32. If C₁₀=C₂₀, this increment equals h/2 and the resulting voltage becomes h. This continues and the output of the unity gain buffer 36 takes on a step shape. If the output is passed through the low pass filter L.P. the output signal becomes a smooth ramp.

It may be appreciated that the described arrangements according to the present invention can utilise existing analog video signals as input signals.

### EXAMPLE

An example was implemented using the circuits described above, with polysilicon TFTs. Using a data voltage range of 0V to 5V, 256 gray scales were implemented.

After the data transfer, which typically occurs in the first 20 μs, the frame period was divided into 256 sections. For a frame rate of 50 cycles/s, the time difference for each additional gray scale is given by Δt=1/50÷256=78.125 μs, and the corresponding data voltage difference is given by ΔV=5÷256=19.53 mV. It is noted that for gray scale=0 the OELD must not be turned on at all.

FIGS. 12A and 12B show the first five (GS=1 to 5) and last five (GS=252 to 256) gray scales, respectively. The area under the pulses are calculated and plotted against the gray scale. As shown in FIGS. 12A and 12B, there is good linearity of pixel brightness within the gray scaling. However, a difference in slope is noted. This is believed to be due to the round corner in the pulse trailing edges, caused by the circuit's stray capacitance. This results in a smaller change in brightness for the lower gray scale values. This is not a serious problem and can be corrected by adjusting the input signal.

The current required by the driver is small compared to the current flowing in to the electroluminescent element.

Generally, the image quality which can be achieved with the present invention has been found to be superior to conventional Liquid Crystal Displays and at least equal to that of conventional CRT displays. In addition, the low power consumption required by the display device of the present invention makes it ideal for mobile and portable apparatus.

Modifications

As will already be appreciated, although much of the detail given above in relation to specific embodiments has been in terms of organic electroluminescent display devices; the present invention is also applicable to other types of display devices. Further, althought the above described embodiments have mentioned specific implementation using TFT technology, usually in polysilicon,; the present invention is not limited to the use of TFT technology. The invention is applicable not only to thin film transistor technology but also to silicon based transistors. Silicon based transistors can be arranged on a display substrate using several different methods. For example, silicon based transistors can be arranged in a liquid.

The present invention is advantageous for use in small, mobile electronic products such as mobile phones, computers, CD players, DVD players and the like—although it is not limited thereto.

Several electronic apparatuses using a display device according to the present invention will now be described.

<1: Mobile Computer>

An example in which the display device according to one of the above embodiments is applied to a mobile personal computer will now be described.

FIG. 13 is an isometric view illustrating the configuration of this personal computer. In the drawing, the personal computer 1100 is provided with a body 1104 including a keyboard 1102 and a display unit 1106. The display unit 1106 is implemented using a display panel fabricated according to the present invention, as described above.

<2: Portable Phone>

Next, an example in which the display device is applied to a display section of a portable phone will be described. FIG. 14 is an isometric view illustrating the configuration of the portable phone. In the drawing, the portable phone 1200 is provided with a plurality of operation keys 1202, an earpiece 1204, a mouthpiece 1206, and a display panel 100. This display panel 100 is implemented using a display panel fabricated according to the present invention, as described above.

<3: Digital Still Camera>

Next, a digital still camera using an OEL display device as a finder will be described. FIG. 15 is an isometric view illustrating the configuration of the digital still camera and the connection to external devices in brief

Typical cameras sensitize films based on optical images from objects, whereas the digital still camera 1300 generates imaging signals from the optical image of an object by photoelectric conversion using, for example, a charge coupled device (CCD). The digital still camera 1300 is provided with an OEL element 100 at the back face of a case 1302 to perform display based on the imaging signals from the CCD. Thus, the display panel 100 functions as a finder for displaying the object. A photo acceptance unit 1304 including optical lenses and the CCD is provided at the front side (behind in the drawing) of the case 1302.

When a cameraman determines the object image displayed in the OEL element panel 100 and releases the shutter, the image signals from the CCD are transmitted and stored to memories in a circuit board 1308. In the digital still camera 1300, video signal output terminals 1312 and input/output terminals 1314 for data communication are provided on a side of the case 1302. As shown in the drawing, a television monitor 1430 and a personal computer 1440 are connected to the video signal terminals 1312 and the input/output terminals 1314, respectively, if necessary. The imaging signals stored in the memories of the circuit board 1308 are output to the television monitor 1430 and the personal computer 1440, by a given operation.

Examples of electronic apparatuses, other than the personal computer shown in FIG. 13, the portable phone shown in FIG. 14, and the digital still camera shown in FIG. 15, include television sets, view-finder-type and monitoring-type video tape recorders, car navigation systems, pagers, electronic notebooks, portable calculators, word processors, workstations, TV telephones, point-of-sales system (POS) terminals, and devices provided with touch panels. Of course, the above described embodiments of the present invention can be applied to the display sections of these electronic apparatuses.

1. A display device comprising a driver circuit which modulates the duty cycle of the on-state of a pixel during a frame period.

2. A display device as claimed in claim 1, wherein a respective one of the said driver circuits is provided for each pixel in the matrix.

3. A display device as claimed in claim 1 or claim 2, wherein the driver circuit comprises a comparator.

4. A display device as claimed in claim 3, wherein the comparator is formed of thin film transistors.

5. A display device as claimed in claim 4, wherein the thin film transistors are formed of polysilicon.

6. A display device as claimed in any of claims 3 to 5, wherein the said driver circuit comprises a data storage capacitor connected to one input of the comparator and a time varying signal line connected to another input of the comparator.

7. A display device as claimed in any of claims 3 to 6, wherein the comparator comprises a differential pair circuit and an inverter circuit.

8. A display device as claimed in any preceding claim, wherein the display device is an active matrix display device.

9. A display device as claimed in any preceding claim, wherein the display device is an organic electroluminescent display device.

10. A display device as claimed in claim 9, comprising a common operating voltage line for the light emitting element of each pixel and a driving circuit supply voltage line which is separate from the common operating voltage line.

11. A method of driving a display device comprising the step of modulating the duty cycle of the on-state of a pixel during a frame period.

12. A method as claimed in claim 11, wherein the step of modulating the duty cycle comprises a comparison of a data signal with a time varying signal.

13. A method as claimed in claim 12, comprising the step of providing the time varying signal in the form of a sawtooth waveform.

14. A method as claimed in claim 12, comprising the step of providing the time varying signal in the form of a triangular shaped waveform.

15. A method as claimed in any of claims 12 to 14, comprising the step of selecting the display device to be an active matrix display device.

16. A method as claimed in claim 15, comprising the step of driving the rows of the matrix using a common waveform generator which provides a row-to-row phase shift in the time varying signal applied to sequential rows.

17. An electronic apparatus including a display device as claimed in any of claims 1 to 10.
